(19) United States
(12) Patent Application Publication
(10) Pub. No.: US 2011/0114257 A1
(43) Pub. Date: May 19, 2011

(54) REACTION PRODUCTS BASED ON AMPHIPHILIC BLOCK COPOLYMERS AND THEIR USE AS IMPACT MODIFIER

(75) Inventors: Andreas Kramer, Zurich (CH); Jurgen Finter, Zurich (CH)

(73) Assignee: Sika Technology AG, Baar (CH)

(21) Appl. No.: 13/054,248

(22) PCT Filed: Jul. 17, 2009
(86) PCT No.: PCT/EP2009/059202

§ 371 Date: Jan. 14, 2011

(30) Foreign Application Priority Data
Jul. 18, 2008 (EP) 08160713.7

(51) Int. Cl. B32B 38/16; C08G 63/91; C08G 81/00

(52) U.S. Cl. 156/281; 525/437; 525/445; 525/438; 525/50

(57) ABSTRACT

Novel impact modifiers obtained by the reaction of amphiphilic block copolymers. These impact modifiers are suitable for use in thermosetting epoxy resin adhesives. The impact modifiers include a carboxylic acid group prepared from the reaction of an intramolecular anhydride of a di- or tricarboxylic acid with at least one amphiphilic block copolymer including at least one hydroxyl group. A method for adhesively binding heat-stable substrates includes applying a single-component thermosetting epoxy resin composition to the surface of a first heat-stable substrate; contacting the epoxy resin composition with the surface of second heat-stable substrate; heating the epoxy resin composition to 20-100° C.; bringing the two substrates and the epoxy resin composition into contact with a wash liquid; and heating the epoxy resin composition to 140-220° C.

### TECHNICAL FIELD

The invention relates to the field of impact modifiers and to the field of thermosetting epoxy resin compositions.

### PRIOR ART

Impact modifiers have been used for quite some time to improve the strength of adhesives under the effect of sudden force. Epoxy resin compositions in particular generally have high mechanical strength, but they are very brittle; i.e., under the effect of sudden force such as that occurring in a collision of vehicles, for example, the cured epoxy resin ruptures, resulting in destruction of the bond.

Proposals have been made in the past for increasing the impact strength by the use of impact modifiers.

Liquid rubbers have been used for quite some time for impact modification. For example, liquid rubbers based on acrylonitrile/butadiene copolymers have been used, such as those available under the name Hypro™ (formerly Hycar®).

EP 0 338 985 A2 describes impact-resistant epoxy resin compositions, which in addition to liquid rubbers based on acrylonitrile/butadiene copolymers contain liquid rubbers based on polyurethane prepolymers which are terminated by a phenol or a lactam.

WO 2005/007766 A1 discloses epoxy resin compositions containing a reaction product of a prepolymer terminated by an isocyanate group, and a blocking agent selected from the group comprising bisphenol, phenol, benzyl alcohol, aminophenol, and benzylamine. However, such epoxy resin compositions exhibit weakness with regard to low-temperature impact strength (<0° C.).

WO 03/093387 A1 discloses impact-resistant epoxy resin compositions containing addition products of dicarboxylic acids with glycidyl ethers, or addition products of bis(aminophenyl)sulfone isomers or aromatic alcohols with glycidyl ethers. However, these compositions likewise have shortcomings with regard to low-temperature impact strength (<0° C.).

The use of amphiphilic block copolymers for epoxy resin compositions has been recently proposed in WO 2006/052725 A1, WO 2006/052726 A1, WO 2006/052727 A1, WO 2006/052728 A1, WO 2006/052729 A1, WO 2006/052730 A1, and WO 2005/097893 A1, for example.

However, it has been shown that, although these impact modifiers have an effect, this increase in impact strength is inadequate, in particular with regard to low-temperature impact strength.

### DESCRIPTION OF THE INVENTION

The object of the present invention, therefore, is to provide novel impact modifiers which improve the impact strength, in particular at low temperatures.

Surprisingly, it has been found that this object may be achieved using impact modifiers according to claims 1 and 6.

It has been found that these impact modifiers are best suited for use in thermosetting epoxy resin adhesives. In particular, it has been shown that combinations of different impact modifiers according to the invention with one another and/or with other impact modifiers are particularly advantageous. It has been shown that there are little or no adverse effects on the glass transition temperature (T_{g}) of the cured matrix as the result of using these impact modifiers. Using epoxy resins, glass transition temperatures of greater than 100° C., sometimes even greater than 130° C., may be achieved. Furthermore, it has been shown that compositions having higher tensile strengths and tensile shear strengths may be obtained.

Further aspects of the present invention are the subject matter of the further independent claims. Particularly preferred embodiments are the subject matter of the dependent claims.

### APPROACHES FOR CARRYING OUT THE INVENTION

In a first aspect, the present invention relates to an impact modifier containing carboxylic acid group(s), which is prepared from the reaction of an intramolecular anhydride of a di- or tricarboxylic acid with at least one amphiphilic block copolymer containing at least one hydroxyl group.

The impact modifier may contain one or more carboxylic acid groups.

References in the entire present document to the prefix “poly” in “polyepoxide,” “polyol,” and “polyphenol” refer to molecules which formally contain two or more of the respective functional groups.

In the present document, “epoxide group” or “epoxy group” refers to the structural element

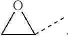

The glycidyl group is a preferred epoxy group.

In the present document, “impact modifier” is understood to mean an additive to a plastic matrix, in particular an epoxy resin matrix, which even at low addition quantities, in particular 0.1-35% by weight, preferably 0.5-15% by weight, results in a distinct increase in the toughness of the cured matrix and which is therefore able to absorb fairly high bending, tensile, impact, or shock stress before the matrix ruptures or breaks.

In the present document, “amphiphilic block copolymer” is understood to mean a copolymer which contains at least one block segment which is miscible with epoxy resin, and at least one block segment which is immiscible with epoxy resin. Amphiphilic block copolymers in particular are those disclosed in WO 2006/052725 A1, WO 2006/052726 A1, WO 2006/052727 A1, WO 2006/052728 A1, WO 2006/052729 A1, WO 2006/052730 A1, or WO 2005/097893 A1, the contents of which are hereby incorporated by reference.

Examples of block segments which are miscible in epoxy resin include in particular polyethylene oxide, polypropylene oxide, poly(ethylene oxide-co-propylene oxide), and poly(ethylene oxide-ran-propylene oxide) blocks, and mixtures thereof.

Examples of block segments immiscible in epoxy resin on the one hand include in particular polyether blocks prepared from alkylene oxides which contain at least four C atoms, preferably butylene oxide, hexylene oxide, and/or dodecylene oxide. Polybutylene oxide, polyhexylene oxide, and polydodecylene oxide blocks and mixtures thereof are particularly preferred as such polyether blocks.

Examples of block segments immiscible in epoxy resin on the other hand include in particular polyethylene, polyethylene-propylene, polybutadiene, polyisoprene, polydimethylsiloxane, and polyalkyl methacrylate blocks and mixtures thereof.

In one embodiment, the amphiphilic block copolymer containing at least one hydroxyl group is a block copolymer of ethylene oxide and/or propylene oxide and at least one further alkylene oxide containing at least four C atoms, preferably from the group comprising butylene oxide, hexylene oxide, and dodecylene oxide.

In another preferred embodiment, the amphiphilic block copolymer containing at least one hydroxyl group is selected from the group comprising poly(isoprene block-ethylene oxide) block copolymers (PI-b-PEO), poly(ethylene-propylene-b-ethylene oxide) block copolymers (PEP-b-PEO), poly(butadiene-b-ethylene oxide) block copolymers (PB-b-PEO), poly(isoprene-b-ethylene oxide-b-isoprene) block copolymers (PI-b-PEO-PI), poly(isoprene-b-ethylene oxide-methyl methacrylate) block copolymers (PI-b-PEO-b-PMMA), and poly(ethylene oxide)-b-poly(ethylene-alt-propylene) block copolymers (PEO-PEP).

The amphiphilic block copolymers may be present in particular in diblock, triblock, or tetrablock form. For multiblocks, i.e., in particular for tri- or tetrablocks, these may be present in linear or branched, in particular in star block, form.

The preparation of the amphiphilic block copolymers is known to one skilled in the art, for example from Macromolecules 1996, 29, 6994-7002 and Macromolecules 2000, 33, 9522-9534, and J. Polym. Sci. Part B: Polym. Phys. 2007, 45, 3338-3348, the disclosures of which are hereby incorporated by reference. The amphiphilic block copolymer contains at least one hydroxyl group. The amphiphilic block copolymer may contain one or more hydroxyl groups, depending on the preparation method.

If, for example, the polymerization of alkylene oxides is initiated using methanol and terminated using acid, this results in an amphiphilic block copolymer containing a hydroxyl group.

On the other hand, if a diol, for example ethylene glycol, is used to initiate the polymerization, an amphiphilic block copolymer containing two hydroxyl groups is correspondingly obtained.

Use of alcohols containing three, four, or more hydroxyl groups as starter correspondingly results in amphiphilic block copolymers containing three, four, or more hydroxyl groups.

The preparation may be carried out, for example, in a sequential synthesis process in which the first monomer, for example butylene oxide, is first polymerized with the assistance of a starter, followed by addition of the second monomer, for example ethylene oxide, which is polymerized to the end of the resulting polymer of the first monomer. Thus, for example, using a monol as starter, a poly(ethylene oxide)-b-poly(butylene oxide) (PEO-PBO) amphiphilic diblock copolymer may be prepared. Use of a diol results, for example, in a poly(ethylene oxide)-b-poly(butylene oxide)-poly(ethylene oxide) (PEO-PBO-PEO) amphiphilic triblock copolymer. However, a first monomer, for example butylene oxide, may be polymerized first with the assistance of a starter, followed by addition of a mixture of two or more monomers, for example a mixture of ethylene oxide and butylene oxide, which is polymerized to the end of the resulting polymer of the first monomer. Thus, for example, a poly(ethylene oxide/butylene oxide)-poly(butylene oxide)-poly(ethylene oxide/butylene oxide) (PEO/BO-PBO-PEO/BO) amphiphilic block copolymer may be prepared.

The impact modifier containing a carboxylic acid group or groups is prepared from the reaction of at least one amphiphilic block copolymer, containing at least one hydroxyl group, with an intramolecular anhydride of a di- or tricarboxylic acid.

An intramolecular anhydride of a di- or tricarboxylic acid may typically be formed from the corresponding di- or tricarboxylic acid by dehydration with ring closure. In this manner an anhydride group is intramolecularly formed. Such intramolecular anhydrides of a di- or tricarboxylic acid are characterized in that the anhydride group is part of a ring.

Particularly suitable intramolecular anhydrides of a di- or tricarboxylic acid are in particular those selected from the group comprising maleic anhydride, 2-methyl maleic anhydride, 2,2-dimethyl maleic anhydride, 2,3-dimethyl maleic anhydride, malonic acid anhydride, 2-methyl malonic acid anhydride, 2,2-dimethyl malonic acid anhydride, succinic acid anhydride, glutaric acid anhydride, adipic acid anhydride, pimelic acid anhydride, itaconic acid anhydride, diglycolic acid anhydride, (2-dodecen-1-yl)succinic acid anhydride, methyl-norbornene-2,3-dicarboxylic acid anhydride (methyl nadic anhydride), phthalic acid anhydride, 3,4,5,6-tetrahydrophthalic acid anhydride, hexahydrophthalic acid anhydride, homophthalic acid anhydride, and trimellitic acid anhydride.

Intramolecular anhydrides of a di- or tricarboxylic acid are preferred in which a five- or six-member ring is formed in the ring closure for the anhydride formation. Preferred anhydrides of a di- or tricarboxylic acid thus have the following structures:

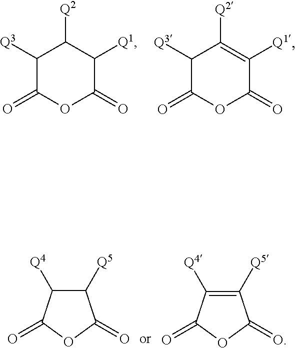

The substituents Q¹, Q², Q³, Q^{1′}, Q^{2′}, Q^{3′}, Q⁴, Q⁵, Q^{4′}, and Q^{5′} each stand for H or for a monofunctional organic radical, or together form a difunctional or trifunctional organic radical.

For the reaction of the amphiphilic block copolymer, containing at least one hydroxyl group, with the intramolecular anhydride of a di- or tricarboxylic acid, the intramolecular anhydride of a di- or tricarboxylic acid and the amphiphilic block copolymer containing at least one hydroxyl group are preferably used in a ratio with respect to one another such that the ratio of the anhydride groups of the anhydride of a di- or tricarboxylic acid to hydroxyl groups of the amphiphilic block copolymer containing at least one hydroxyl group is at least 1.

In this reaction the hydroxyl group(s) of the amphiphilic block copolymer react(s) with the anhydride group of the anhydride of a di- or tricarboxylic acid to form an ester group or groups and a carboxylic acid group or groups.

For better clarity, the preparation of one example of an impact modifier containing carboxylic acid groups is schematically illustrated by the following example:

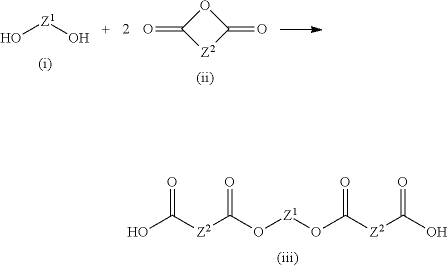

In this regard, Z¹ stands for the radical of an amphiphilic block copolymer containing two hydroxyl groups after removal of the two hydroxyl groups, and Z² stands for the radical of an anhydride after removal of the anhydride group. In the present case, the reaction of the amphiphilic block copolymer with hydroxyl groups of formula (i) with the intramolecular carboxylic acid anhydride of formula (ii) results, for example, in the impact modifier of formula (iii) containing carboxylic acid groups.

This reaction proceeds with high yield and under mild conditions. These conditions and the reaction control are basically known to one skilled in the art.

The impact modifiers containing a carboxylic acid group or groups are typically liquid, or at least flowable, at room temperature.

The impact modifiers containing a carboxylic acid group or groups may be used in numerous ways. Since they result in a marked increase in the toughness of the cured matrix when added to a plastic matrix, in particular an epoxy resin matrix, they are suitable on their own as impact modifiers. However, they may also be used as starting products for the synthesis of derivatives.

Particularly suitable derivatives of this type are the reaction products of the impact modifiers with polyepoxides.

Thus, impact modifiers prepared from the reaction of such an impact modifier containing a carboxylic acid group or groups described above with at least one polyepoxide represent a further aspect of the present invention.

The polyepoxide preferably represents a diepoxide, in particular a diglycidyl ether.

On the one hand, so-called epoxy reactive diluents are particularly suited as polyepoxide. The polyepoxides discussed in detail below as reactive diluent G are particularly suited as such reactive diluents.

On the other hand, the polyepoxides discussed in detail below as epoxy resin A are particularly suited as polyepoxides.

The polyepoxide is particularly preferably a diglycidyl ether of a bisphenol. The polyepoxide is most preferably a diglycidyl ether of bisphenol-A.

In one embodiment, the impact modifier containing a carboxylic acid group or groups and the polyepoxide for the reaction are used together in a ratio with respect to one another such that the ratio of the carboxylic acid groups of the impact modifier containing a carboxylic acid group or groups to the epoxy groups of the polyepoxide is greater than 1.

In this case, impact modifiers containing carboxylic acid groups are obtained.

For better clarity, reference is made once again to the previously mentioned example. From the reaction of the impact modifier of formula (iii) containing carboxylic acid groups, for example, an excess of a polyepoxide of formula (iv), for example, with respect to the impact modifier of formula (v) containing carboxylic acid groups, for example, is reacted:

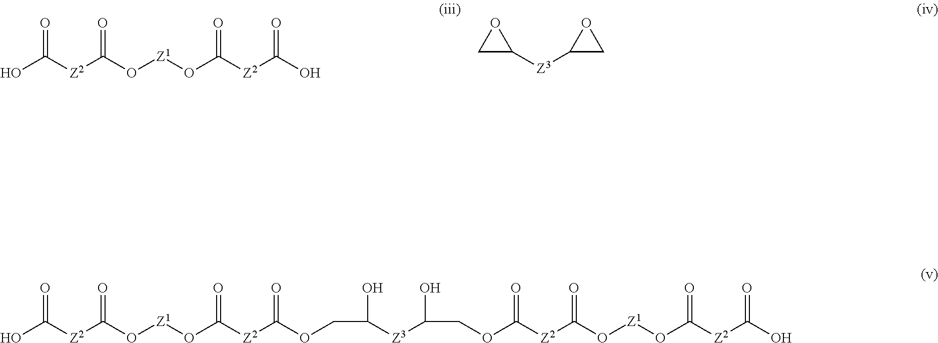

In this regard, Z³ stands for the radical of a diepoxide after removal of the two epoxy groups.

In another particularly preferred embodiment, the impact modifier containing a carboxylic acid group or groups and, the polyepoxide for the reaction are used together in a ratio with respect to one another such that the ratio of the carboxylic acid groups of the impact modifier containing a carboxylic acid group or groups to the epoxy groups of the polyepoxide is less than 1.

In this case, impact modifiers containing epoxy groups are obtained.

For better clarity, here as well reference is made once again to the previously mentioned example. From the reaction of the impact modifier of formula (iii) containing carboxylic acid groups, for example, an excess of a polyepoxide of formula (Iv), for example, with respect to the impact modifier of formula (vi) containing epoxy, for example, is reacted:

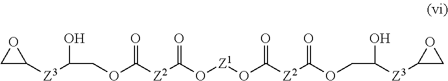

In both embodiments, polyepoxide groups are reacted with carboxylic acid groups. One skilled in the art is very familiar with the conditions, in particular the temperatures and catalysts, for such a reaction.

The impact modifiers containing carboxylic acid groups or the impact modifiers containing epoxy groups prepared in this manner are typically liquid or at least flowable at room temperature.

It is also clear to one skilled in the art that the impact modifiers containing carboxylic acid groups or the impact modifiers containing epoxy groups prepared in this manner may in turn be used as starting products for further reactions, in particular with polyepoxides, polyamines, polyols, or polyisocyanates.

The described impact modifiers containing a carboxylic acid group or groups or containing epoxy groups results in a distinct increase in the toughness of the [cured matrix] when added to a plastic matrix, in particular an epoxy resin matrix, and are therefore best suited as impact modifiers.

These impact modifiers may in particular be a constituent of single- or dual-component adhesives, sealants, coatings, and coverings, in particular floor coverings. Such systems are preferably represented by epoxy resin compositions.

In a further aspect, the present invention relates to a single-component thermosetting epoxy resin composition containing
at least one epoxy resin A containing on average greater than one epoxy group per molecule;
at least one hardener B for epoxy resins which is activated at elevated temperature; and
at least one impact modifier as previously described.

Epoxy resin A containing on average greater than one epoxy group per molecule is preferably an epoxy liquid resin or an epoxy solid resin. The term “epoxy solid resin” is well known to one with specialized knowledge in the field of epoxies, and is used in contrast to the term “epoxy liquid resin.” The glass transition temperature of solid resins is above room temperature; i.e., the solid resins may be comminuted at room temperature to form free-flowing powders.

Preferred epoxy solid resins have formula (X):

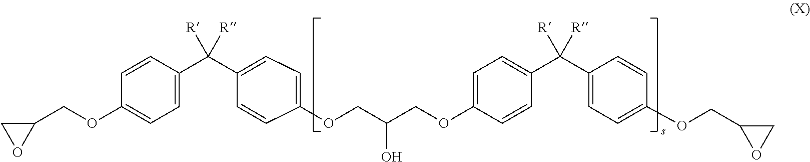

In this regard, substituents R′ and R″ independently stand for either H or CH₃. In addition, the subscript s stands for a value>1.5, in particular 2 to 12.

Such epoxy solid resins are commercially available from Dow, Huntsman, or Hexion, for example.

Compounds of formula (X) having a subscript s with a value between 1 and 1.5 are referred to by those skilled in the art as semisolid epoxy resins. They are also considered as solid resins for the present invention. However, epoxy resins in the narrower sense, i.e., in which the subscript s has a value>1.5, are preferred.

Preferred epoxy liquid resins have formula (XI):

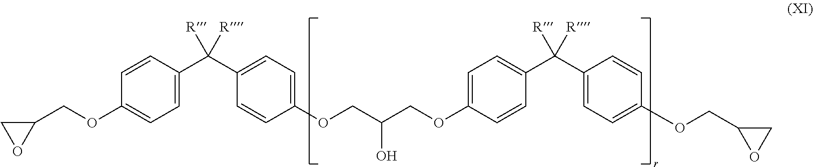

In this regard, substituents R″′ and R″″ independently stand for either H or CH₃. In addition, the subscript r stands for a value of 0 to 1. r preferably stands for a value less than 0.2.

Diglycidyl ethers of bisphenol-A (DGEBA), of bisphenol-F, and of bisphenol-A/F are preferred. Such liquid resins are available, for example, as Araldite® GY 250, Araldite® PY 304, or Araldite® GY 282 (Huntsman), as D.E.R.™ 331 or D.E.R.™ 330 (Dow), or as Epikote 828 (Hexion).

Also suited as epoxy resin A are so-called novolacs, which in particular have the following formula:

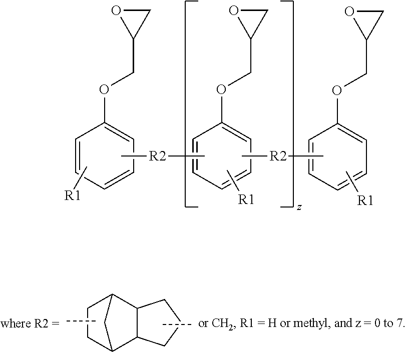

These are phenol novolacs or cresol novolacs (R2=CH₂) in particular.

Such epoxy resins are commercially available under the trade names EPN, ECN, and Tactix®556 from Huntsman, or under the product series D.E.N.™ from Dow Chemical.

The epoxy resin A is preferably represented by an epoxy liquid resin of formula (XI). In an even more preferred embodiment, the thermosetting epoxy resin composition contains at least one epoxy liquid resin of formula (XI) and at least one epoxy solid resin of formula (X).

The proportion of epoxy resin A is preferably 10-85% by weight, in particular 15-70% by weight, preferably 15-60% by weight, relative to the weight of the composition.

It has been shown to be advantageous when multiple impact modifiers according to the invention are used in combination.

The proportion of the above-described impact modifier is preferably 145% by weight, in particular 35% by weight, relative to the weight of the composition.

The composition according to the invention also contains at least one hardener B for epoxy resins which is activated at elevated temperature. This is preferably a hardener selected from the group comprising dicyandiamide, guanamine, guanidine, aminoguanidine, and derivatives thereof. Also possible are hardeners having an accelerating action, such as substituted ureas, for example 3-(3-chloro-4-methylphenyl)-1,1-dimethylurea (chlortoluron), or phenyldimethylureas, in particular p-chlorophenyl-N,N-dimethylurea (monuron), 3-phenyl-1,1-dimethylurea (fenuron), or 3,4-dichlorophenyl-N,N-dimethylurea (diuron), N,N-dimethylurea, N-isobutyl-N′,N′-dimethylurea, and addition products of diisocyanates and dialkylamines. Examples of such addition products of diisocyanates and dialkylamines are 1,1′-(hexane-1,6-diyl)bis(3,3′-dimethylurea), which is easily obtainable by reacting hexamethylene diisocyanate (HDI) and dimethylamine, or the analogous urea compound resulting from the addition of isophorone diisocyanate (IPDI) to dimethylamine. Compounds of the class of the imidazoles, imidazolines, and amine complexes may also be used.

Hardener B is preferably a hardener selected from the group comprising dicyandiamide, guanamine, guanidine, aminoguanidine, and derivatives thereof; substituted ureas, in particular 3-(3-chloro-4-methylphenyl)-1,1-dimethylurea (chlortoluron), or phenyldimethylureas, in particular p-chlorophenyl-N,N-dimethylurea (monuron), 3-phenyl-1,1-dimethylurea (fenuron), 3,4-dichlorophenyl-N,N-dimethylurea (diuron), N,N-dimethylurea, N-isobutyl-N′,N′-dimethylurea, 1,1′-(hexane-1,6-diyl)bis(3,3′-dimethylurea), and imidazoles, imidazole salts, imidazolines, and amine complexes.

Dicyandiamide is particularly preferred as hardener B.

The total proportion of hardener B is advantageously 140% by weight, preferably 2-8% by weight, relative to the weight of the overall composition.

The thermosetting epoxy resin composition may also contain a thixotropic agent C based on a urea derivative. The urea derivative in particular is a reaction product of an aromatic monomeric diisocyanate with an aliphatic amine compound. It is also possible to react several different monomeric diisocyanates with one or more aliphatic a mine compounds, or to react a monomeric diisocyanate with multiple aliphatic amine compounds. The reaction product of 4,4′-diphenylmethylene diisocyanate (MDI) with butylamine has proven to be particularly advantageous.

The urea derivative is preferably present in a carrier material. The carrier material may be a softener, in particular a phthalate or an adipate, preferably a diisodecyl phthalate (DIDP) or dioctyl adipate (DOA). The carrier agent may also be a nondiffusing carrier agent. This is preferred in order to ensure minimum migration of unreacted constituents after curing. Blocked polyurethane prepolymers are preferred as nondiffusing carrier agents.

The preparation of such preferred urea derivatives and carrier materials is described in detail in patent application EP 1 152 019 A1, the content of which is hereby incorporated by reference. The carrier material is advantageously a blocked polyurethane prepolymer, in particular obtained by reacting a trifunctional polyether polyol with IPDI, followed by blocking of the end-position isocyanate groups with ε-caprolactam.

The total proportion of thixotropic agent C is advantageously 0-40% by weight, preferably 5-25% by weight, relative to the weight of the overall composition. The ratio of the weight of the urea derivative to the weight of the optionally present carrier agent is preferably 2/98 to 50/50, in particular 5/95 to 25/75.

It has also been shown to be particularly advantageous when the thermosetting single-component epoxy resin composition also contains at least one further impact modifier D in addition to the previously described impact modifier.

The additional impact modifiers D may be solid or liquid.

In one embodiment, this impact modifier D is a liquid rubber D1, which is a carboxyl- or epoxy-terminated acrylonitrile/butadiene copolymer or a derivative thereof. Such liquid rubbers are commercially available, for example, under the names Hypro™ (formerly Hycar®) CTBN, CTBNX, and ETBN from Nanoresins AG, Germany, or from Emerald Performance Materials LLC. Elastomer-modified prepolymers containing in particular epoxy groups, as marketed under the product line Polydis®, preferably the product line Polydis® 36. from Struktol (Schill+Seilacher Groups, Germany), or under the product line Albipox (Nanoresins, Germany), are suitable as derivatives.

In another embodiment, the impact modifier D is a polyacrylate liquid rubber D2 which is fully miscible with liquid epoxy resins and which does not demix to form microdroplets until the epoxy resin matrix has cured. Such polyacrylate liquid rubbers are available, for example, under the trade name 20208-XPA from Rohm and Haas.

It is clear to one skilled in the art that mixtures of liquid rubbers may of course also be used, in particular mixtures of carboxyl- or epoxy-terminated acrylonitrile/butadiene copolymers or derivatives thereof with epoxy-terminated polyurethane prepolymers.

In another embodiment, impact modifier D is a solid impact modifier which is an organic ion-exchanged layered mineral DE1.

The ion-exchanged layered mineral DE1 may be either a cation-exchanged layered mineral DE1c or an anion-exchanged layered mineral DE1a.

The cation-exchanged layered mineral DE1c is obtained from a layered mineral DE1′ in which at least a portion of the cations have been exchanged with organic cations. Examples of such cation-exchanged layered minerals DE1c are in particular those mentioned in U.S. Pat. No. 5,707,439 or U.S. Pat. No. 6,197,849. The cited documents also describe the method for producing these cation-exchanged layered minerals DE1c. A layered silicate is preferred as layered mineral DE1′. The layered mineral DE1′ is particularly preferably a phyllosilicate, in particular a bentonite, as described in U.S. Pat. No. 6,197,849, column 2, line 38 to column 3, line 5. A layered mineral DE1′ such as kaolinite, a montmorillionite, a hectorite, or an illite has been shown to be particularly suitable.

At least a portion of the cations in the layered mineral DE1′ are replaced by organic cations. Examples of such cations include n-octylammonium, trimethyldodecylammonium, dimethyldodecylammonium, or bis(hydroxyethyl)octadecylammonium, or similar derivatives of amines which may be obtained from natural fats and oils; or guanidinium cations or amidinium cations; or cations of the N-substituted derivatives of pyrrolidine, piperidine, piperazine, morpholine, or thiomorpholine; or cations of 1,4-diazobicyclo[2.2.2]octane (DABCO) and 1-azobicyclo[2.2.2]octane; or cations of N-substituted derivatives of pyridine, pyrrole, imidazole, oxazole, pyrimidine, quinoline, isoquinoiline, pyrazine, indole, benzimidazole, benzoxaziole, thiazole, phenazine, and 2,2′-bipyridine. Also suitable are cyclic amidinium cations, in particular those disclosed in U.S. Pat. No. 6,197,849 in column 3, line 6 to column 4, line 67. Compared to linear ammonium compounds, cyclic ammonium compounds are characterized by increased thermal stability since they do not undergo the thermal Hoffmann degradation reaction.

Preferred cation-exchanged layered minerals DE1c are known to one skilled in the art under the term “organoclay” or “nanoclay,” and are commercially available, for example, under the group names Tixogel® or Nanofil® (Südchemie), Cloisite® (Southern Clay Products), Nanomer® (Nanocor Inc.), or Garmite® (Rockwood).

The anion-exchanged layered mineral DE1a is obtained from a layered mineral DE1″ in which at least a portion of the anions have been exchanged with organic anions. One example of such an anion-exchanged layered mineral DE1a is a hydrotalcite DE1″, in which at least a portion of the carbonate anions of the intermediate layers have been exchanged with organic anions.

It is also possible for the composition to contain both a cation-exchanged layered mineral DE1c and an anion-exchanged layered mineral DE1a.

In another embodiment, the impact modifier D is a solid impact modifier which is a block copolymer DE2. The block copolymer DE2 is obtained from an anionic polymerization or controlled radical polymerization of methacrylate with at least one further monomer containing an olefinic double bond. Particularly preferred as monomers containing an olefinic double bond are monomers in which the double bond is directly conjugated with a heteroatom or with at least one further double bond. Particularly suited are monomers selected from the group comprising styrene, butadiene, acrylonitrile, and vinyl acetate. Acrylate/styrene/acrylonitrile copolymers (ASA), obtainable under the name GELOY 1020 from GE Plastics, for example, are preferred.

Particularly preferred block copolymers DE2 are block copolymers of methyl methacrylate, styrene, and butadiene. Such block copolymers are available, for example, as triblock copolymers under the group name SBM from Arkema.

In another embodiment, impact modifier D is a core-shell polymer DE3. Core-shell polymers are composed of an elastic core polymer and a rigid shell polymer. Particularly suited core-shell polymers are composed of a core of elastic acrylate or butadiene polymer which encloses a rigid shell of an inflexible thermoplastic polymer. This core-shell structure is formed either spontaneously as the result of demixing of a block copolymer, or is specified by the polymerization control as latex or suspension polymerization with subsequent grafting. Preferred core-shell polymers are so-called MBS polymers, which are commercially available under the trade names Clearstrength™ from Atofina, Paraloid™ from Rohm and Haas, or F-351™ from Zeon.

Core-shell polymer particles which are already present as dried polymer latex are particularly preferred. Examples of such include GENIOPERL M23A from Wacker, having a polysiloxane core and an acrylate shell, radiation-crosslinked rubber particles of the NEP series manufactured by Eliokem, Nanoprene from Lanxess, or Paraloid EXL from Rohm and Haas.

Further comparable examples of core-shell polymers are marketed under the name Albidur™ from Nanoresins AG, Germany.

Also suitable are nanoscale silicates in an epoxy matrix, marketed under the trade name Nonopox from Nanoresins AG, Germany.

In another embodiment, the impact modifier D is a product DE4 of the reaction of a carboxylated solid nitrile rubber with excess epoxy resin.

In another embodiment, the toughness enhancer D is a blocked polyurethane polymer of formula (IV).

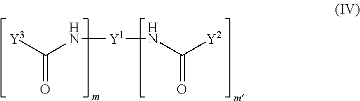

In this regard, m and m′ each stand for values between 0 and 8, with the condition that m+m′ stands for a value from 1 to 8.

m is preferably different from 0.

In addition, Y¹ stands for a linear or branched polyurethane polymer PU1, terminated by m+m′ isocyanate groups, after removal of all end-position isocyanate groups.

Y² independently stands for a blocking group which cleaves at a temperature above 100° C.

Y³ independently stands for a group of formula (IV′).

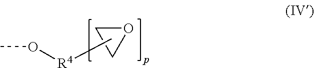

In this regard, R⁴ stands for a radical of an aliphatic, cycloaliphatic, aromatic, or araliphatic epoxy, containing a primary or secondary hydroxyl group, after removal of the hydroxide and epoxy groups, and p stands for the values 1, 2, or 3.

In the present document, “araliphatic radical” refers to an aralkyl group, i.e., an alkyl group substituted with aryl groups (see Römpp, CD Römpp's Chemical Lexicon, Version 1, Stuttgart/New York, Georg Thieme Verlag 1995).

In particular, Y² independently stands for a substituent selected from the group comprising

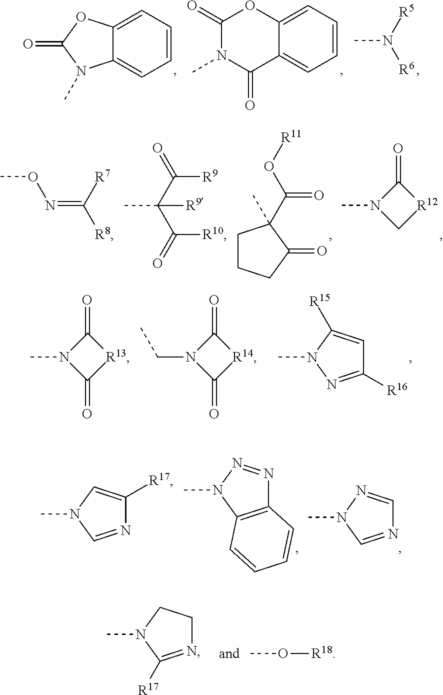

In this regard R⁵, R⁶, R⁷, and R⁸ each independently stand for an alkyl, cycloalkyl, aralkyl, or arylalkyl group, or R⁵ together with R⁶, or R⁷ together with R⁸, forms a part of a 4- to 7-membered ring which is optionally substituted.

In addition, R⁹, R^{9′}, and R¹⁰ each independently stand for an alkyl, aralkyl, or arylalkyl group or for an alkyloxy, aryloxy, or aralkyloxy group, and R′¹ stands for an alkyl group.

R¹², R¹³, and R¹⁴ each independently stand for an alkylene group containing 2 to 5 C atoms, and optionally having double bonds or being substituted, or stand for a phenylene group or a hydrogenated phenylene group, and R¹⁵, R¹⁶, and R¹⁷ each independently stand for H or for an alkyl, aryl, or aralkyl group.

Lastly, R¹⁸ stands for an aralkyl group or for a mononuclear or polynuclear substituted or unsubstituted aromatic group which optionally contains aromatic hydroxyl groups.

The dashed lines in the formulas in, the present document in each case represent the bond between the particular substituent and the associated molecular moiety.

On the one hand, R¹⁸ in particular represents phenols or bisphenols after removal of a hydroxyl group. Preferred examples of such phenols and bisphenol are in particular phenol, cresol, resorcinol, pyrocatechol, cardanol (3-pentadecenylphenol (from cashew shell oil)), nonylphenol, phenols reacted with styrene or dicyclopentadiene, bis-phenol-A, bis-phenol-F, and 2,2′-diallyl bisphenol-A.

On the other hand, R¹⁸ in particular represents hydroxybenzyl alcohol and benzyl alcohol after removal of a hydroxyl group.

If R⁵, R⁶, R⁷, R⁸, R⁹, R^{9′}, R¹⁰, R¹¹, R¹⁵, R¹⁶, or R¹⁷ stands for an alkyl group, this group in particular is a linear or branched C₁-C₂₀-alkyl group.

If R⁵, R⁶, R⁷, R⁸, R⁹, R^{9′}, R¹⁰, R¹⁵, R¹⁶, R¹⁷, or R¹⁸ stands for an aralkyl group, this group in particular is an aromatic group bonded via methylene, in particular a benzyl group.

If R⁵, R⁶, R⁷, R⁸, R⁹, R^{9′}, or R¹⁰ stands for an alkylaryl group, this group in particular is a C₁-C₂₀-alkyl group bonded via phenylene, for example tolyl or xylyl.

Particularly preferred Y² radicals are radicals selected from the group comprising

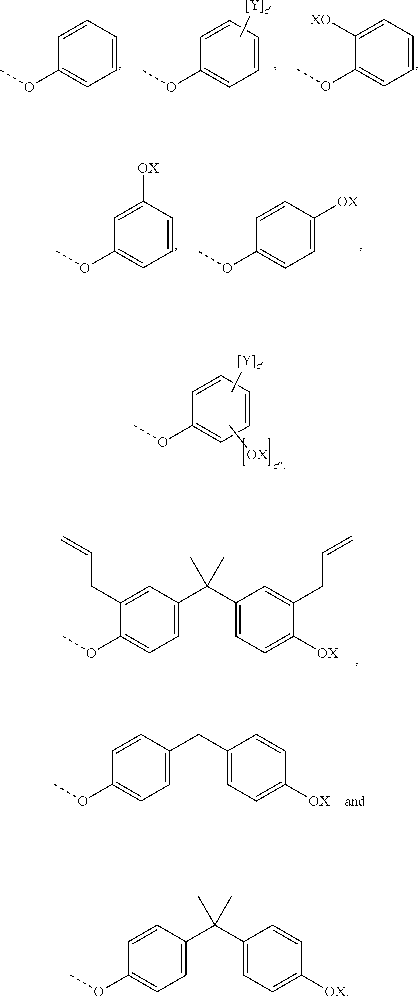

In this regard, the radical Y stands for a saturated or olefinically unsaturated hydrocarbon radical containing 1 to 20 C atoms, in particular 1 to 15 C atoms. Allyl, methyl, nonyl, dodecyl, or an unsaturated C₁₅-alkyl radical containing 1 to 3 double bonds is particularly preferred as Y.

The radical X stands for H or for an alkyl, aryl, or aralkyl group, in particular for H or methyl.

The subscripts z′ and z″ stand for the values 0, 1, 2, 3, 4, or 5, with the condition that the sum z′+z″ stands for a value between 1 and 5.

The blocked polyurethane polymer of formula (IV) is prepared by [reacting] the linear or branched polyurethane polymer PU1, terminated by the isocyanate groups, with one or more isocyanate-reactive compounds Y²H and/or Y³H. If more than one such isocyanate-reactive compound is used, the reaction may be carried out sequentially or using a mixture of these compounds.

The reaction is carried out in such a way that the one or more isocyanate-reactive compounds Y²H and/or Y³H are used stoichiometrically or in stoichiometric excess to ensure that all NCO groups are reacted.

The isocyanate-reactive compound Y³H is a monohydroxyl epoxy compound of formula (IVa).

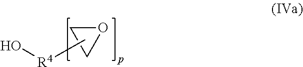

If more than one such monohydroxyl epoxy compound is used, the reaction may be carried out sequentially or using a mixture of these compounds.

The monohydroxyl epoxy compound of formula (IVa) contains 1, 2, or 3 epoxy groups. The hydroxyl group of this monohydroxyl epoxy compound (IVa) may represent a primary or a secondary hydroxyl group.

Such monohydroxyl epoxy compounds may be prepared, for example, by reacting polyols with epichlorohydrin. Depending on the reaction control, the corresponding monohydroxyl epoxy compounds are also formed in various concentrations as by-products in the reaction of polyfunctional alcohols with epichlorohydrin. These by-products may be isolated using customary separating operations. However, it is generally sufficient to use the product mixture, composed of polyol which is completely and partially reacted to form the glycidyl ether, obtained in the glycidylization reaction of polyols. Examples of such hydroxyl-containing epoxides are butanediol monoglycidyl ether (present in butanediol diglycidyl ether), hexanediol monoglycidyl ether (present in hexanediol diglycidyl ether), cyclohexanedimethanol glycidyl ether, trimethylolpropane diglycidyl ether (present as a mixture in trimethylolpropane triglycidyl ether), glycerin diglycidyl ether (present as a mixture in glycerin triglycidyl ether), and pentaerythrite triglycidyl ether (present as a mixture in pentaerythrite tetraglycidyl ether). Preferably used is trimethylolpropane triglycidyl ether, which is present in a relatively high proportion in commonly prepared trimethylolpropane triglycidyl ethers.

However, other similar hydroxyl-containing epoxides, in particular glycidol, 3-glycidyloxybenzyl alcohol, or hydroxymethylcyclohexene oxide, may also be used. Also preferred is the β-hydroxy ether of formula (IVb), which is contained in proportions up to approximately 15% in commercially available liquid epoxy resins produced from bisphenol-A (R═CH₃) and epichlorohydrin, as well as the corresponding β-hydroxy ethers of formula (IVb), which are formed when bisphenol-F (R═H) or the mixture of bisphenol-A and bisphenol-F is reacted with epichlorohydrin.

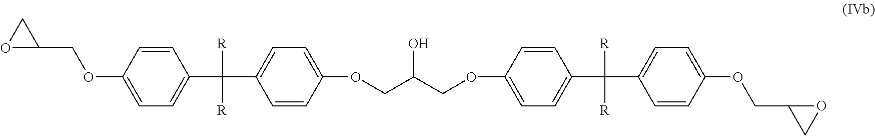

Also preferred are distillation residues which are produced in the preparation of high-purity distilled epoxy liquid resins. Such distillation residues have a concentration of hydroxyl-containing epoxides that is one to three times higher than in commercially available undistilled epoxy liquid resins. In addition, various epoxides may be used which contain a β-hydroxy ether group, prepared by the reaction of (poly-)epoxides with a deficit of monofunctional nucleophiles such as carboxylic acids, phenols, thiols, or secondary amines.

The R⁴ radical particularly preferably is a trifunctional radical of formula

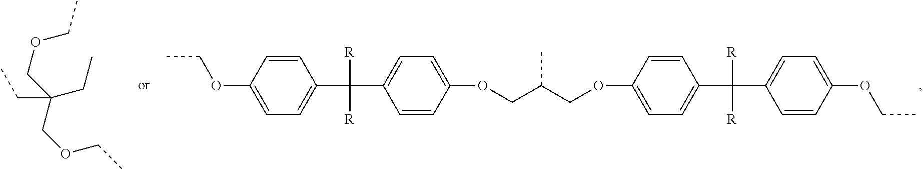

where R stands for methyl or H.

The free primary or secondary OH functionality of the monohydroxyl epoxide compound of formula (IV a) allows an efficient reaction with terminal isocyanate groups of polymers without having to use disproportionate excesses of the epoxide component.

The polyurethane polymer PU1, based on Y¹, may be prepared from at least one diisocyanate or triisocyanate and at least one polymer Q_{PM} containing end-position amino, thiol, or hydroxyl groups, and/or from an optionally substituted polyphenol Q_{PP}.

Examples of suitable diisocyanates include aliphatic, cycloaliphatic, aromatic, or araliphatic diisocyanates, in particular commercially available products such as methylenediphenyl diisocyanate (MDI), 1,4-butane diisocyanate, hexamethylene diisocyanate (HDI), toluene diisocyanate (TDI), tolidine diisocyanate (TODI), isophorone diisocyanate (IPDI), trimethylhexamethylene diisocyanate (TMDI), 2,5- or 2,6-bis-(isocyanatomethyl)-bicyclo[2.2.1]heptane, 1,5-naphthalene diisocyanate (NDI), dicyclohexylmethyl diisocyanate (H₁₂MDI), p-phenylene diisocyanate (PPDI), or m-tetramethylxylylene diisocyanate (TMXDI), and the dimers thereof. HDI, IPDI, MDI, or TDI are preferred.

Examples of suitable triisocyanates are trimers or biurets of aliphatic, cycloaliphatic, aromatic, or araliphatic diisocyanates, in particular the isocyanurates and biurets of the diisocyanates described in the preceding paragraph.

Of course, suitable mixtures of di- or triisocyanates may also be used.

Polymers Q_{PM} containing two or three end-position amino, thiol, or hydroxyl groups are particularly suited as polymers Q_{PM} containing end-position amino, thiol, or hydroxyl groups.

Particularly suited as polymers Q_{PM} are those disclosed, for example, in WO 2008/049857 A1, in particular as Q_{PM} on page 7, line 25 to page 11, line 20, the content of which is in particular incorporated by reference.

The polymers Q_{PM} advantageously have an equivalent weight of 300-6000, in particular 600-4000, preferably 700-2200, g/equivalent NCO-reactive groups.

Particularly suited as polymers Q_{PM} are polyoxyalkylene polyols, also referred to as polyether polyols, hydroxy-terminated polybutadiene polyols, styrene-acrylonitrile grafted polyether polyols, polyhydroxy-terminated acrylonitrile/butadiene copolymers, polyester polyols, and polycarbonate polyols.

The amphiphilic block copolymers used for preparing the previously described impact modifiers containing a carboxylic acid group or groups and containing at least one hydroxyl group have proven to be particularly suitable as polymers Q_{PM}, in particular those marketed under the trade name Fortegra™, in particular Fortegra™ 100, from Dow Chemical.

Particularly suited as polyphenol Q_{PP} are bis-, tris-, and tetraphenols. These are understood to mean not only pure phenols but also optionally substituted phenols. Various types of substitution may be used. This is understood in particular to mean a substitution directly at the aromatic nucleus to which the phenolic OH group is bound. In addition, the term “phenols” refer s not only to mononuclear aromatics, but also to polynuclear or condensed aromatics or heteroaromatics which contain the phenolic OH group directly on the aromatic or heteroaromatic.

The bis- and trisphenols are particularly suited. Examples of suitable bisphenols or trisphenols include 1,4-dihydroxybenzene, 1,3-dihydroxybenzene, 1,2-dihydroxybenzene, 1,3-dihydroxytoluene, 3,5-dihydroxybenzoate, 2,2-bis(4-hydroxyphenyl)propane (=bisphenol-A), bis(4-hydroxyphenyl)methane (=bisphenol-F), bis(4-hydroxyphenyl)sulfone (=bisphenol-S), naphthoresorcinol, dihydroxynaphthalene, dihydroxyanthraquinone, dihydroxybiphenyl, 3,3-bis(p-hydroxyphenyl)phthalide, 5,5-bis(4-hydroxyphenyl)hexahydro-4,7-methanoindan, phenolpthalein, fluorescein, 4,4′-[bis-(hydroxyphenyl)-1,3-phenylene-bis-(1-methylethylidene)] (=bisphenol-M), 4,4′-[bis-(hydroxyphenyl)-1,4-phenylene-bis-(1-methylethylidene)] (=bisphenol-P), 2,2′-diallyl bisphenol-A, diphenols and dicresols prepared by reacting phenols or cresols with di-isopropylidenebenzene, phloroglucin, gallic acid esters, phenol or cresol novolacs having an OH functionality of 2.0 to 3.5, and all isomers of the above-mentioned compounds.

Particularly suited as impact modifier D which is optionally present in the composition are those disclosed in the following articles or patent documents, whose content is hereby incorporated by reference: EP 0 308 664 A1, in particular formula (I), especially page 5, line 14 to page 13, line 24; EP 0 338 985 A1, EP 0 353 190 A1, WO 00/20483 A1, in particular formula (I), especially page 8, line 18 to page 12, line 2; WO 01/94492 A1, in particular the reaction products referred to as D) and E), especially page 10, line 15 to page 14, line 22; WO 03/078163 A1, in particular the acrylate-terminated polyurethane resin referred to as B), especially page 14, line 6 to page 14, line 35; WO 2005/007766 A1, in particular formula (I) or (II), especially page 4, line 5 to page 11, line 20; EP 1 728 825 A1, in particular formula (I), especially page 3, line 21 to page 4, line 47; WO 2006/052726 A1, in particular the amphiphilic block copolymer referred to as b), especially page 6, line 17 to page 9, line 10; WO 2006/052729 A1, in particular the amphiphilic block copolymer referred to as b), especially page 6, line 25 to page 10, line 2; T. J. Hermel-Davidock et al., J. Polym. Sci. Part B: Polym. Phys. 2007, 45, 3338-3348, in particular the amphiphilic block copolymers, especially page 3339, column 2 to page 3341, column 2; WO 2004/055092 A1, in particular formula (I), especially page 7, line 28 to page 13, line 15; WO 2005/007720 A1, in particular formula (I), especially page 8, line 1 to page 17, line 10; WO 2007/020266 A1, in particular formula (I), especially page 3, line 1 to page 11, line 6; WO 2008/049857 A1, in particular formula (I), especially page 3, line 5 to page 6, line 20; WO 2008/049858 A1, in particular formulas (I) and (II), especially page 6, line 1 to page 12, line 15; WO 2008/049859 A1, in particular formula (I), especially page 6, line 1 to page 11, line 10; WO 2008/049860 A1, in particular formula (I), especially page 3, line 1 to page 9, line 6; and DE-A-2 123 033, US 2008/0076886 A1, WO 2008/016889, and WO 2007/025007.

It has been shown that more than one impact modifier is advantageously present in the composition, in particular also more than one impact modifier D.

The proportion of impact modifiers D is advantageously used in a quantity of 145% by weight, in particular 1-35% by weight, relative to the weight of the composition.

In another preferred embodiment, the composition also contains at least one filler F. Preferred as such are mica, talc, kaolin, wollastonite, feldspar, syenite, chlorite, bentonite, montmorillonite, calcium carbonate (precipitated or pulverized), dolomite, quartz, silicic acids (pyrogenic or precipitated), cristobalite, calcium oxide, aluminum hydroxide, magnesium oxide, hollow ceramic beads, hollow glass beads, organic hollow beads, glass beads, and colored pigments. The organically coated as well as uncoated forms, which are commercially available and known to one skilled in the art, are also intended as filler F.

Functionalized alumoxanes as described in U.S. Pat. No. 6,322,890, for example, represent another example.

The overall proportion of the total filler F is advantageously 3-50% by weight, preferably 5-35% by weight, in particular 5-25° A) by weight, relative to the weight of the overall composition.

In another preferred embodiment the composition contains a physical or chemical blowing agent, such as those available, for example, under the trade names Expancel™ from Akzo Nobel or Celogen™ from Chemtura. The proportion of blowing agent is advantageously 0.1-3% by weight, relative to the weight of the composition.

In another preferred embodiment, the composition also contains a reactive diluent G containing at least one epoxide group. These reactive diluents G are in particular the following:
Glycidyl ethers of monofunctional saturated or unsaturated, branched or unbranched, cyclic or open-chain C₄-C₃₀ alcohols, in particular selected from the group comprising butanol glycidyl ether, hexanol glycidyl ether, 2-ethylhexanol glycidyl ether, allyl glycidyl ether, tetrahydrofurfuryl and furfuryl glycidyl ethers, and trimethoxysilyl glycidyl ether.
Glycidyl ethers of difunctional saturated or unsaturated, branched or unbranched, cyclic or open-chain C₂-C₃₀ alcohols, in particular selected from the group comprising ethylene glycol, butanediol, hexanediol, and octanediol gylcidyl ethers, cyclohexanedimethanol diglycidyl ether, and neopentyl glycol diglycidyl ether.
Glycidyl ethers of tri- or polyfunctional, saturated or unsaturated, branched or unbranched, cyclic or open-chain alcohols such as epoxidized castor bean oil, epoxidized trimethylolpropane, epoxidized pentaerythrol, or polyglycidyl, ethers of aliphatic polyols such as sorbitol, glycerin, or trimethylolpropane.
Glycidyl ethers of phenol and aniline compounds, in particular selected from the group comprising phenyl glycidyl ether, cresyl glycidyl ether, p-tert-butylphenyl glycidyl ether, nonylphenol glycidyl ether, 3-n-pentadecenyl glycidyl ether (from cashew shell oil), N,N-diglycidylaniline, and the triglycidyl [ether] of p-aminophenol.
Epoxidized amines such as N,N-diglycidylcyclohexylamine.
Epoxidized mono- or dicarboxylic acids, in particular those selected from the group comprising neodecanoic acid glycidyl esters, methacrylic acid glycidyl esters, benzoic acid glycidyl esters, phthalic acid, tetra- and hexahydrophthalic acid diglycidyl esters, and diglycidyl esters of dimeric fatty acids, and terephthalic acid and trimellitic acid gylcidyl esters.
Epoxidized di- or trifunctional, low- to high-molecular polyether polyols, in particular polyethylene glycol-diglycidyl ether or polypropylene glycol-diglycidyl ether.

Particularly preferred are hexanediol diglycidyl ether, cresyl glycidyl ether, p-tert-butylphenyl glycidyl ether, polypropylene glycol diglycidyl ether, and polyethylene glycol diglycidyl ether.

The total proportion of reactive diluent G, containing the epoxide groups, is advantageously 0.1-20% by weight, preferably 1-8% by weight, relative to the weight of the overall composition.

The composition may include further constituents, in particular catalysts, stabilizers, especially heat and/or light stabilizers, thixotropic agents, softeners, solvents, mineral or organic fillers, blowing agents, dyes and pigments, anticorrosion agents, surfactants, antifoaming agents, and bonding agents.

Particularly suited as softeners are phenol alkyl sulfonate and N-butylbenzenesulfonamide, which are commercially available from Bayer as Mesamoll® and Dellatol BBS, respectively.

Particularly suited as stabilizers are optionally substituted phenols such as BHT or Wingstay® T (Elikem), sterically hindered amines, or N-oxyl compounds such as TEMPO (Evonik).

The described thermosetting epoxy resin compositions after curing are characterized by high impact strength and a glass transition temperature of greater than 100° C., in particular greater than 120° C., sometimes even greater than 130° C.

It has been shown that the described thermosetting epoxy resin compositions are particularly suited as single-component adhesives. Such a single-component adhesive has many applications. In particular, thermosetting single-component adhesives may thus be obtained which are characterized by high impact strength at higher temperatures and in particular at low temperatures, in particular between 0° C. and −40° C. Such adhesives are necessary for bonding heat-stable materials. Heat-stable materials are understood to mean materials which are dimensionally stable at a curing temperature of 100-220° C., preferably 120-200° C., at least during the curing time. These involve in particular metals, and plastics such as ABS, polyamide, and polyphenylene ether, composite materials such as SMC, GFRP unsaturated polyester, and epoxy or acrylate composites. The application in which at least one material is a metal is preferred. A particularly preferred use is the adhesive bonding of identical or different metals, in particular for body shells in the automotive industry. The preferred metals are primarily steel, in particular electrogalvanized steel, hot-dip galvanized steel, lubricated steel, Bonazinc-coated steel, and subsequently phosphated steel, as well as aluminum, in particular in the variants typically used in automobile manufacture.

The desired combination of high crash resistance and high as well as low operating temperatures may be achieved using an adhesive based on a thermosetting composition according to the invention.

Such an adhesive is in particular first contacted with the materials to be bonded, at a temperature between 10° C. and 80° C., in particular between 10° C. and 60° C., and is subsequently cured at a temperature of typically 100-220° C., preferably 120-200° C.

A further aspect of the present invention relates to a method for adhesively bonding heat-stable substrates, having the following steps:
α) Applying a single-component thermosetting epoxy resin composition, as described in detail above, to the surface of a heat-stable substrate S1, in particular a metal;
β) Contacting the applied thermosetting epoxy resin composition with the surface of a further heat-stable substrate S2, in particular a metal;
γ) Heating the epoxy resin composition to a temperature of 100 to 130° C., preferably 115 to 125° C.;
δ) Bringing the substrates S1 and S2 and the thermosetting epoxy resin composition in contact with them into contact with a wash liquid at a temperature between 20 and 100° C., in particular between 40 and 70° C., preferably between 50 and 70° C.; and
ε) Heating the composition to a temperature of 140-220° C., in particular 140-200° C., preferably 160-190° C.

The substrate S2 is composed of a material which is identical to or different from substrate S1.

A bonded article results from such a method for adhesively bonding heat-stable materials. Such an article is preferably a vehicle or a mounted part of a vehicle.

Of course, in addition to thermosetting adhesives, sealants or coatings may be realized using a composition according to the invention. Furthermore, the compositions according to the invention are suitable for other applications besides automobile manufacture. Mentioned in particular are related applications in the manufacture of transport means such as ships, trucks, buses, or rail vehicles, or in the manufacture of consumer goods such as washing machines, for example.

The materials adhesively bonded using a composition according to the invention are used at temperatures that are typically between 120° C. and −40° C., preferably between 100° C. and −40° C., in particular between 80° C. and −40° C.

It is particularly preferred to use the thermosetting epoxy resin composition according to the invention as a thermosetting adhesive for body shells in automotive manufacture.

A further aspect of the present invention relates to the use of amphiphilic block copolymers containing at least one hydroxyl group for producing impact modifiers containing a carboxylic acid group or groups, in particular as described above.

### EXAMPLES

### Preparation of CGAS Impact Modifier Containing Carboxylic Acid Groups

110.0 g Fortegra™ 100 (OH number: 16 mg/g KOH) and 4.74 g phthalic acid anhydride (Fluka) were stirred at 140° C. for 2 hours under nitrogen, and for an additional 2 hours under vacuum. A viscous CGAS polymer containing carboxylic acid groups and having an acid number of 15.5 mg/g KOH (15.7 mg/g KOH theoretical) was obtained.

Preparation of EGAS Impact Modifier Containing Epoxy Groups

The CGAS impact modifier containing carboxylic acid groups, prepared as described above, was further reacted by adding 165 g D.E.R. 331 epoxy resin (Dow) and 0.55 triphenylphosphine, and stirring the mixture for 3 hours at 120° C. under vacuum. A viscous EGAS polymer containing epoxy groups and having an epoxy content of 3.14 eq/kg (3.15 eq/kg theoretical) was obtained.

Preparation of SM1 Impact Modifier

150 g poly-THF®2000 (OH number 57 mg/g KOH, BASF) and 150 g Liquiflex H (OH number 46 mg/g KOH, Krahn) were dried for 30 minutes at 105° C. under vacuum. After the temperature was reduced to 90° C., 64.0 g isophorone diisocyanate and 0.13 g dibutyltin dilaurate were added. The reaction was carried out under vacuum at 90° C. until the NCO content was constant at 3.30% after 2.5 h (calculated NCO content: 38%). 103.0 g Cardolite® NC-700 (Cardanol, Cardolite) was then added as blocking agent. Stirring of the mixture continued under vacuum at 105° C. until the NCO content had dropped below 0.1% after 3.5 h.

Preparation of SM2 Impact Modifier

90 g Hypro™ CTBN 1300X13 (acid number approximately 29 mg/g KOH, Nanoresins), 60 g Hypro™ CTBN 1300X8 (acid number approximately 32 mg/g KOH, Nanoresins), and 23.2 g Araldite® GT7071 (epoxy equivalent weight approximately 510 g/eq, Huntsman) were stirred together with 0.75 g triphenylphosphine and 0.38 g butylhydroxytoluene (BHT) for 2 hours at 140° C. under vacuum. 201.8 g D.E.R. 354 (Dow) was then added, and stirring was continued for 2 h at 140° C. under vacuum. A viscous resin having an epoxy content of approximately 2.8 eq/kg was obtained.

Preparation of SM3 Impact Modifier

318.0 g Jeffamine® T-3000 (Huntsman) and 30.4 g maleic anhydride (Fluka) were stirred for 2 h at 120° C. under nitrogen. 802 g D.E.R. 331 (Dow) and 2.9 g triphenylphosphine were then added, and stirring was continued at 110° C. under vacuum until a constant epoxy content was reached. After approximately 2 h a viscous resin having an epoxy content of approximately 3.5 eq/kg was obtained.

Preparation of SM4 Impact Modifier

200.0 g (approximately 0.4 eq epoxy groups) D.E.R. 671 (Dow) and 75.0 g (approximately 0.4 eq epoxy groups) D.E.R. 331 (Dow) were stirred for 15 minutes at 120° C. under vacuum until a homogeneous solution was obtained. 230.0 g (approximately 0.23 eq NH) Jeffamine® D-4000 (Huntsman) and 0.5 g (approximately 0.007 eq NH) Jeffamine® T-403 (Huntsman) were then added. After stirring under vacuum for 3 h at 120° C. and for 1 h at 130° C., a clear, viscous resin having a calculated epoxy content of approximately 1.13 eq/kg (epoxy equivalent weight=approximately 890 g/eq) was obtained.

Preparation of the Compositions

The reference compositions Ref1 to Ref4 and the compositions 1 to 4 according to the invention as presented in Table 1 were prepared. In each case the constituents are given in parts by weight. Particular care was taken that the compositions each contained the same quantities of epoxy groups as the corresponding reference example. For the comparative examples containing unreacted amphiphilic block copolymer (Fortegra™ 100), for the corresponding examples according to the invention the quantity of the respective impact modifier according to the invention was selected in such a way that it contained the same quantity of amphiphilic block copolymer as the starting product.

Test Methods:

Tensile Shear Strength (TSS) (DIN EN 1465)

The test specimens were produced from the described example compositions, using electrogalvanized DC04 steel (eloZn) having dimensions of 100×25×1.5 mm or 100×25×0.8 mm, with an adhesive surface of 25×10 mm and a layer thickness of 0.3 mm. Curing was performed for 30 min at 180° C. The tensile speed was 10 mm/min.

Tensile Strength (TS) (DIN EN ISO 527)

An adhesive sample was pressed between two sheets of Teflon paper to a layer thickness of 2 mm. The adhesive was then cured for 30 minutes at 180° C. The Teflon papers were removed, and the test specimens were punched out in the hot state according to the DIN standard. After storage for one day under standard climatic conditions, the measured tensile speed of the test specimens was 2 mm/min.

The tensile strength was determined according to DIN EN ISO 527.

Cleavage Resistance Under Impact Loading (ISO 11343)

The test specimens were produced from the described example compositions, using electrogalvanized DC04 steel (eloZn) having dimensions of 90×20×0.8 mm, with an adhesive surface of 20×30 mm and a layer thickness of 0.3 mm. Curing was performed for 30 min at 180° C. The cleavage resistance under impact loading was measured in each case at room temperature and at −30° C. The impact speed was 2 m/s. The area under the measurement curve from (25% to 90% according to ISO 11343) is given as the fracture energy (FE) in joules.

Glass Transition Temperature (T_{g})

The glass transition temperature was determined by DSC using a Mettler DSC822^{e} instrument. In each case 10-20 mg of the compositions were weighed into an aluminum crucible. After the sample had cured in the DSC for 30 min at 175° C., it was cooled to −20° C. and then heated to 150° C. at a heating rate of 10° C./min. The glass transition temperature was determined as the mean value from the measured DSC curve, using DSC software.

The test results are presented in Table 2 [sic: 1]:

TABLE 1
Compositions and results.

| | Ref1 | 1 | Ref2 | 2 | Ref3 | 3 | Ref4 | 4 |
|---|---|---|---|---|---|---|---|---|
| D. E. R. ™ | 50.0 | 40.0 | 45.0 | 36.0 | 30.0 | 21.0 | 45.0 | 36.0 |
| 331 | | | | | | | | |
| Polypox R7 | 3.0 | 3.0 | 3.0 | 3.0 | 3.0 | 3.0 | 3.0 | 3.0 |
| EGAS | | 17.0 | | 17.0 | | 17.0 | | 17.0 |
| Fortegra ™ | 7.0 | | 7.0 | | 7.0 | | 7.0 | |
| 100 | | | | | | | | |
| SM1 | 15.0 | 15.0 | | | | | | |
| SM2 | | | 15.0 | 15.0 | | | 15.0 | 15.0 |
| SM3 | | | | | 30.0 | 30.0 | | |
| SM4 | | | | | | | 10.0 | 10.0 |
| Dicyandiamide | 4.1 | 4.1 | 4.4 | 4.4 | 4.1 | 4.1 | 4.4 | 4.4 |
| N,N- | 0.2 | 0.2 | 0.2 | 0.2 | 0.2 | 0.2 | 0.2 | 0.2 |
| dimethylurea | | | | | | | | |
| Filler mixture | 19.0 | 19.0 | 19.0 | 19.0 | 19.0 | 19.0 | 19.0 | 19.0 |
| TS [MPa] | 17.1 | 22.3 | 32.0 | 32.4 | 31.8 | 31.9 | n.m.² | n.m.² |
| TSS [MPa] | 24.2 | 28.9 | 17.1 | 22.4 | 31.7 | 32.3 | 13.7 | 16.5 |
| FE¹ at | 4.9 | 8.4 | 0.2 | 0.8 | 4.2 | 7.4 | 0.3 | 1.7 |
| 23° C. [J] | | | | | | | | |
| FE¹ at | 1.5 | 2.4 | 0.1 | 0.2 | 0.3 | 1.5 | 0.3 | 0.4 |
| −30° C. [J] | | | | | | | | |
| T_{g} [° C.] | 109 | 109 | 132 | 132 | 130 | 130 | 132 | 132 |

¹FE = fracture energy,
²n.m. = not measured.

Table 1 shows that the compositions containing the impact modifier EGAS (representing an example of an impact modifier according to the invention) have increased impact strength compared to the respective comparative composition containing no impact modifier according to the invention. In addition, compositions 1, 2, 3, and 4 have a greater tensile strength and tensile shear strength than the corresponding comparative examples Ref1, Ref2, Ref3, and Ref4.

1. Impact modifier comprising a carboxylic acid group prepared from a reaction of an intramolecular anhydride of a di- or tricarboxylic acid with at least one amphiphilic block copolymer comprising at least one hydroxyl group.

2. Impact modifier comprising the carboxylic acid groups according to claim 1, wherein the amphiphilic block copolymer comprising the at least one hydroxyl group is a block copolymer of ethylene oxide and/or propylene oxide and at least one further alkylene oxide comprising at least four C atoms.

3. Impact modifier comprising the carboxylic acid group according to claim 1, wherein the amphiphilic block copolymer comprising the at least one hydroxyl group is selected from the group consisting of poly(isoprene block-ethylene oxide) block copolymers, poly(ethylene-propylene-b-ethylene oxide) block copolymers, poly(butadiene-b-ethylene oxide) block copolymers, poly(isoprene-b-ethylene oxide-b-isoprene) block copolymers, poly(isoprene-b-ethylene oxide-methyl methacrylate) block copolymers, and poly(ethylene oxide)-b-poly(ethylene-alt-propylene) block copolymers.

4. Impact modifier comprising the carboxylic acid group according to claim 1, wherein the intramolecular anhydride of a di- or tricarboxylic acid is selected from the group consisting of maleic anhydride, 2-methyl maleic anhydride, 2,2-dimethyl maleic anhydride, 2,3-dimethyl maleic anhydride, malonic acid anhydride, 2-methyl malonic acid anhydride, 2,2-dimethyl malonic acid anhydride, succinic acid anhydride, glutaric acid anhydride, adipic acid anhydride, pimelic acid anhydride, itaconic acid anhydride, diglycolic acid anhydride, (2-dodecen-1-yl)succinic acid anhydride, methyl-norbornene-2,3-dicarboxylic acid anhydride (methyl nadic anhydride), phthalic acid anhydride, 3,4,5,6-tetrahydrophthalic acid anhydride, hexahydrophthalic acid anhydride, homophthalic acid anhydride, and trimellitic acid anhydride.

5. Impact modifier comprising the carboxylic acid group according to claim 1, wherein the intramolecular anhydride of a di- or tricarboxylic acid and the amphiphilic block copolymer comprising the at least one hydroxyl group are used in a ratio with respect to one another such that a ratio of the anhydride groups of the anhydride of a di- or tricarboxylic acid to hydroxyl groups of the amphiphilic block copolymer comprising the at least one hydroxyl group is at least 1.

6. Impact modifier prepared from a reaction of an impact modifier comprising the carboxylic acid group according to claim 1 with at least one polyepoxide.

7. Impact modifier according to claim 6, wherein the polyepoxide is a diepoxide.

8. Impact modifier according to claim 6, wherein the impact modifier comprising the carboxylic acid group and the polyepoxide for the reaction are used together in a ratio with respect to one another such that a ratio of the carboxylic acid groups of the impact modifier comprising the carboxylic acid group to the epoxy groups of the polyepoxide is greater than 1.

9. Impact modifier according to claim 6, wherein the impact modifier comprising the carboxylic acid group and the polyepoxide for the reaction are used together in a ratio with respect to one another such that a ratio of carboxylic acid groups of the impact modifier comprising the carboxylic acid group to the epoxy groups of the polyepoxide is less than 1.

10. Single-component thermosetting epoxy resin composition comprising
at least one epoxy resin A containing on average greater than one epoxy group per molecule;
at least one hardener B for epoxy resins which is activated at elevated temperature; and
at least one impact modifier according to claim 1.

11. Single-component thermosetting epoxy resin composition according to claim 10, wherein the hardener B is selected from the group consisting of dicyandiamide, guanamine, guanidine, aminoguanidine, derivatives of aminoguanidine, substituted ureas, phenyldimethylureas, imidazoles, imidazole salts, imidazolines, and amine complexes.

12. Single-component thermosetting epoxy resin composition according to claim 10, wherein the composition further comprises a second impact modifier D.

13. Method for adhesively bonding heat-stable substrates, comprising:
α) applying the single-component thermosetting epoxy resin composition according to claim 10 to a surface of a first heat-stable substrate S1;
β) contacting the epoxy resin composition with a surface of a second heat-stable substrate S2;
γ) heating the epoxy resin composition to a temperature of 100 to 130° C.;
δ) bringing the substrates S1 and S2 and the epoxy resin composition in contact with the substrates S1 and S2 into contact with a wash liquid at a temperature between 20 and 100° C.; and
ε) heating the epoxy resin composition to a temperature of 140-220° C.;
wherein the substrate S2 is composed of a material which is identical to or different from substrate S1.

14. A thermosetting single-component adhesive for body shells in automotive manufacture comprising the single-component thermosetting epoxy resin composition according to claim 10.

15. An amphiphilic block copolymer comprising at least one hydroxyl group for preparing impact modifiers comprising the carboxylic acid group according to claim 1.
